(19) United States
(12) Patent Application Publication
(10) Pub. No.: US 2012/0167378 A1
(43) Pub. Date: Jul. 5, 2012

(54) ANTI-ROTATION DEVICES AND SYSTEMS

(75) Inventor: MICHAEL D. MORELLI, STERLING HEIGHTS, MI (US)

(73) Assignee: GM GLOBAL TECHNOLOGY OPERATIONS LLC, DETROIT, MI (US)

(21) Appl. No.: 12/985,081

(22) Filed: Jan. 5, 2011

(51) Int. Cl. B23P 19/00

(52) U.S. Cl. 29/700

(57) ABSTRACT

A system is provided that is configured to mount a first component to a second component. The system includes an engagement device and an attachment device. The engagement device is attached to the first component. The attachment device is configured to mate with the engagement device to thereby provide mounting of the first component at one of a plurality of angles with respect to the second component while at least inhibiting rotation of the first component with respect to the second component.

### TECHNICAL FIELD

The present disclosure generally relates to the field of anti-rotation devices and, more specifically, to anti-rotation devices and systems with variable positions, such as for use in vehicles.

### BACKGROUND

Automobiles, other vehicles, and various other systems and devices require the mounting of one component with another, such that rotation of the mounted component is prevented or restricted. Generally, the components are mounted at a fixed angle with respect to one another. However, the desired angles may vary from device to device, for example among different vehicles. Accordingly, different anti-rotation devices and/or systems may be required for separate devices and/or vehicles, for example that have different geometries and/or that require different mounting angles.

Accordingly, it is desirable to provide a device and/or system for improved mounting of components, such as in vehicles, at one of a plurality of predetermined angles, while limiting rotation of the mounted component. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a system is provided. The system is configured to mount a first component to a second component. The system comprises an engagement device and an attachment device. The engagement device is attached to the first component. The attachment device is configured to mate with the engagement device to thereby provide mounting of the first component at one of a plurality of angles with respect to the second component while at least inhibiting rotation of the first component with respect to the second component.

In accordance with another exemplary embodiment, a system for mounting a device against a component is provided. The device has a housing. The system comprises a first plurality of teeth and a second plurality of teeth. The first plurality of teeth are integrally formed with the housing. The second plurality of teeth are formed separately from the housing. The second plurality of teeth are configured to engage the first plurality of teeth, to thereby provide mounting of the housing at one of a plurality of angles with respect to the component while at least inhibiting rotation of the housing with respect to the component.

In accordance with a further exemplary embodiment, a device is provided. The device is configured to be mounted against a component. The device comprises a housing and a first plurality of teeth. The first plurality of teeth are integrally formed with the housing. The first plurality of teeth are configured to mate with a second plurality of teeth, to thereby provide mounting of the housing at one of a plurality of angles with respect to the component while at least inhibiting rotation of the housing with respect to the component.

### BRIEF DESCRIPTION OF THE DRAWINGS

The present disclosure will hereinafter be described in conjunction with the following drawing figures, wherein like numerals denote like elements, and wherein:

FIG. 1 is an exploded plan view of a system for mounting one component to another, for example in a vehicle, in accordance with an exemplary embodiment;

FIG. 2 is a plan view of the system of FIG. 1, in accordance with an exemplary embodiment;

FIG. 3 is a close-up plan view of a portion of the system of FIG. 1, including an engagement device having a plurality of teeth and an integrated fastening device, in accordance with an exemplary embodiment;

FIG. 4 is a cross sectional view of a portion of the system of FIG. 1, including an engagement device having a plurality of teeth and an integrated fastening device, in accordance with an exemplary embodiment;

FIG. 5 is a cross sectional view of a portion of the system of FIG. 1, including an engagement device having a plurality of teeth and an integrated fastening device, and including and an attachment device configured to attach to the engagement device, and shown with the integrated fastening device before it is fully engaged, in accordance with an exemplary embodiment;

FIG. 6 is a cross sectional view of a portion of the system of FIG. 1, including an engagement device having a plurality of teeth and an integrated fastening device, and including and an attachment device configured to attach to the engagement device, and shown with the integrated fastening device fully engaged, in accordance with an exemplary embodiment;

FIG. 7 is a close-up perspective view of a portion of the system of FIG. 1, including an engagement device and an attachment device configured to attach to one another, and shown prior to such attachment, in accordance with an exemplary embodiment;

FIG. 7 is a close-up perspective view of a portion of the system of FIG. 1, including an engagement device and an attachment device configured to attach to one another, and shown prior to such attachment, in accordance with an exemplary embodiment;

FIG. 8 is a close-up perspective view of a portion of the system of FIG. 1, including an engagement device and an attachment device configured to attach to one another, and shown during partial attachment of the engagement device and the attachment device, in accordance with an exemplary embodiment;

FIG. 9 is a close-up perspective view of a portion of the system of FIG. 1, including an engagement device and an attachment device configured to attach to one another, and shown during full attachment of the engagement device and the attachment device, in accordance with an exemplary embodiment;

FIG. 10 is a cross sectional view of the of the system of FIG. 1, depicted as attached to another component, for example of a vehicle, in accordance with an exemplary embodiment;

FIG. 11 is a plan view of the system of FIG. 1, depicted as attached to the other component of FIG. 10 at a first angle, in accordance with an exemplary embodiment;

FIG. 12 is a plan view of the system of FIG. 1, depicted as attached to the other component of FIG. 10 at a second angle, in accordance with an exemplary embodiment; and

FIG. 13 is a plan view of the system of FIG. 1, depicted as attached to the other component of FIG. 10 at a second angle, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

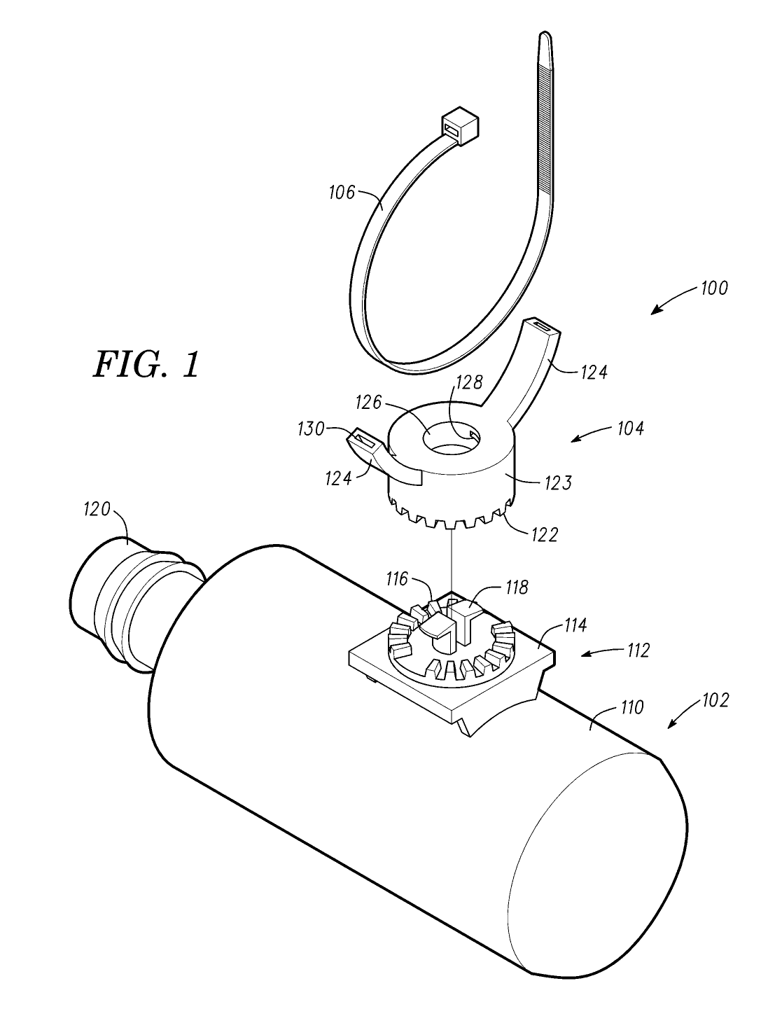

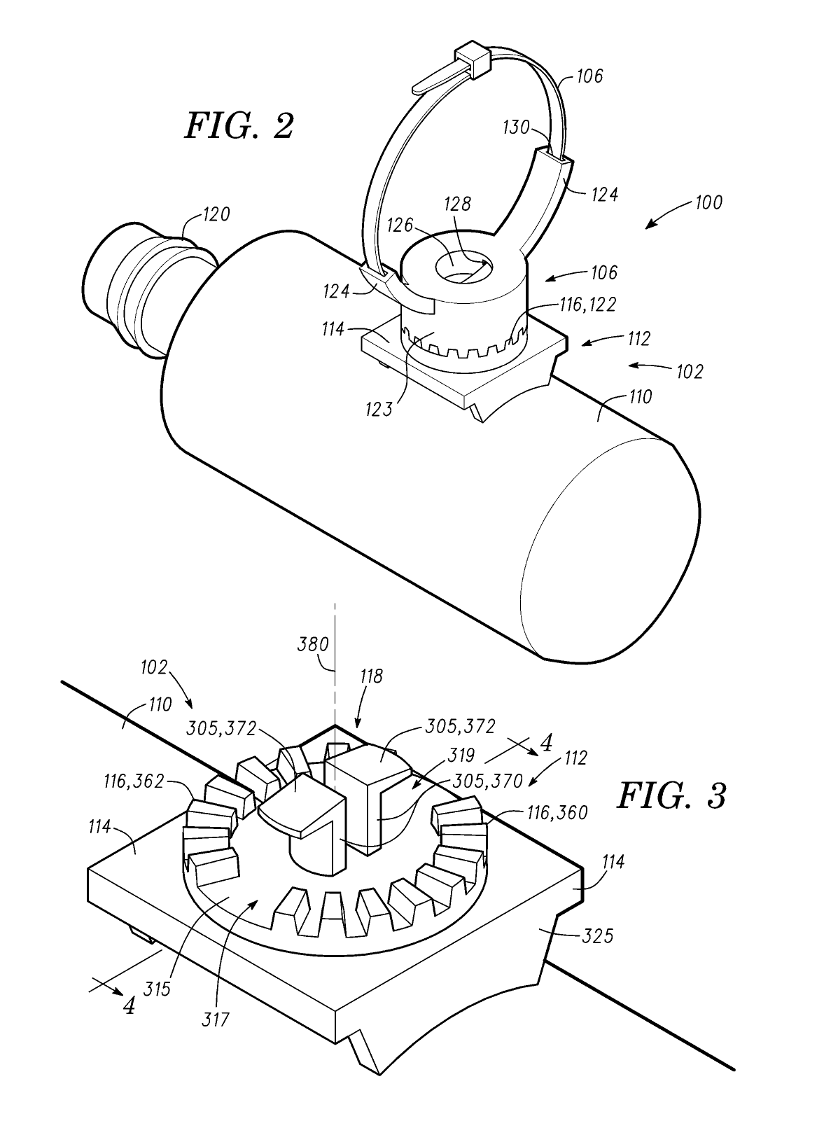

FIGS. 1 and 2 depict a system 100 for mounting one component to another, in accordance with an exemplary embodiment. Specifically, FIG. 1 depicts the system 100 in an exploded plan view, and FIG. 2 depicts the system 100 in a non-exploded plan view. In one exemplary embodiment, the system 100 is for use within a vehicle. However, this may vary in other embodiments.

As depicted in FIGS. 1 and 2, the system 100 includes a component 102, an attachment device 104, and a tie rod 106. The system 100 is configured to provide mounting of the component 102 against another component (not depicted in FIGS. 1 and 2), such as in a vehicle. The component 102 includes a base 110 and an engagement device 112. In certain embodiments, the base 110 may be referred to as a housing. In other embodiments, the base 110 and the engagement device 112 may collectively be referred to as the housing. Regardless, the entire component 102 is mounted against the other component (not depicted in FIGS. 1 and 2) at a predetermined one of a plurality of angles with respect to the component. In one embodiment, the component 102 comprises an air filter for a vehicle, and includes one or more openings 120 for air to travel through. Also in one embodiment, the component 102 is configured to be mounted against a fill pipe of the vehicle. However, this may vary in other embodiments. In one such embodiment, the air filter 102 and the other component are both part of an evaporative emissions system for a hybrid vehicle. However, this may also vary in other embodiments.

The engagement device 112 and the attachment device 104 are configured to engage, attach, and mate with one another in a manner that provides for mounting of the component 102 at a predetermined one of a plurality of angles with respect to the other component (not depicted in FIGS. 1 and 2), while at least inhibiting (and preferably preventing) rotation of the component 102 with respect to the other component. For example, in various different applications, it may be necessary or desirable for the component 102 to be mounted at different angles with respect to the other component, for example depending on the specific geometries involved. For example, in a preferred embodiment in which the component 102 comprises an air filter that is configured to be mounted against a fill pipe of the vehicle, the preferred mounting angle may vary depending on the type of vehicle and/or the geometries and/or placement of the fill pipe and/or surrounding components of the vehicle. The mating of the engagement device 112 and the attachment device 104 is configured such that the predetermined angle can be selected from the plurality of angles based on the selective engagement of the first and second teeth 116, 122.

The engagement device includes a plate 114, first teeth 116, and an integrated fastening device 118. The plate 114, the first teeth 116, and the integrated fastening device 118 are formed in the base 110 (or housing). The first teeth 116 are preferably generally spaced apart angularly approximately a predetermined number of degrees (approximately fifteen degrees, in one preferred embodiment) from one another. However, this may vary in other embodiments. Preferably, the plate 114, the first teeth 116, and the integrated fastening device 118 are molded together into the housing as a single piece, most preferably as a plastic material molded together into the single piece. However, the plate 114, the first teeth 116, and/or the integrated fastening device 118 may be separately formed, in other embodiments.

The attachment device 104 includes second teeth 122, a base 123, and protrusions 124. The second teeth 122 are preferably generally spaced apart angularly approximately a predetermined number of degrees (approximately fifteen degrees, in one preferred embodiment) from one another. However, this may vary in other embodiments. In any event, the spacing of the first and second teeth 116, 122 is such that the first and second teeth 116, 122 may fully engage one another (and preferably, the spacing is the same for the first and second teeth 116, 122).

The base 123 is configured to receive the integrated fastening device 118 of the engagement device 112 after the mounting angle is established through alignment and engagement of the first and second teeth 116, 122. The protrusions 124 extend from two opposing sides of the base 123. The attachment device 104 preferably includes an inner portion or opening 126 within the base 123. The inner portion or opening 126 is defined by an inner surface 128 with which the integrated fastening device 118 connects or contacts.

In addition, the protrusions 124 include a separate opening 130 through which the tie rod 106 extends in securing the system 100 with the other component. The second teeth 122, the base 123, and the protrusions 124 are preferably formed as a single piece with one another, but separate from the component 102 prior to the mating of the engagement device 112 and the attachment device 104. The second teeth 122, the base 123, and the protrusions 124 are preferably molded together as a single piece, most preferably as a plastic material. However, the second teeth 122, the base 123, and the protrusions 124 may be separately formed, in other embodiments.

The second teeth 122 of the attachment device 104 engage with respective first teeth 116 of the engagement device 112, to thereby secure the component 102 to the attachment device 104 and prevent rotation of the component 102 (and of the housing thereof) and the attachment device 104, with respect to one another. The predetermined one of the plurality of angles with respect for mounting the component 102 against the other component is attained by selectively aligning the first teeth 116 and the second teeth 122 prior to engagement of the integrated fastening device 118 with the attachment device 104.

The specific angles for the component 102 in relation to the attachment device 104 may be determined by an individual or company seeking to use this system of assembly. Preferably the angle is determined by the packaging, the function, or the combination of both for the component 102. Final angles may also be determined based on surrounding architecture and required clearances of the component 102 to the individual elements of that architecture.

The amount of variability in the mounting angle is determined by the number of the first and second teeth 116, 122 and the resulting angular placement thereof. The number of first teeth 116 is preferably equal to the number of second teeth. In one preferred embodiment, there are twenty four first teeth 116 separated along a plate or ring (such as the ring 305 depicted in FIG. 3 and described further below in connection therewith) at angular increments of 15 degrees apart from another. Also in this preferred embodiment, there are similarly twenty four second teeth 122 separated at angular increments of 15 degrees apart from another. In this embodiment, the mounting angle may be varied in increments of fifteen degrees as a result of the number and placement of the first and second teeth 116, 122. The number of first and second teeth 116, 122 may vary in order to vary the geometric placement therebetween and, consequently, to adjust the increments in which the mounting angle may be varied.

The specific increments of the teeth 116, 122 are preferably determined by the number of teeth 116, 122 contained on both the component 102 and the attachment device 104. Preferably, the increments are determined by dividing the 360 degrees of rotation by the number of teeth 116, 122 to determine the increments available. For example, 24 teeth on each side would result in 15 degree increments, 36 teeth on each side would result in ten degree increments, and so forth. The determination as to the number of teeth 116, 122 can be made up to the individual or individuals seeking to use this system.

Each of the first teeth 116 preferably has a length and width that is at least substantially equal to those of the other first teeth 116, and that is also at least substantially equal to that of each of the second teeth 122. In one embodiment, on the engagement device 112, each individual first tooth 116 is cm wide, with a height of 1.56 cm and a length of 2.5 cm. The length is determined by the outside diameter and inside diameters of the circumference. The outside diameter is 20 cm, while the inside diameter is 15 cm. Also in this embodiment, on the attachment device 104, each individual second tooth 122 measures 1.27 cm wide at the outside diameter and 0.61 cm wide at the inside diameter, with each second tooth 118 being tapered to properly fit into the engagement device 112. The height of each second tooth 122 in this embodiment is 1.35 cm, and the length is the same as the first teeth 116 of the engagement device 112, namely, 2.5 cm. Also in this embodiment, each tooth 116, 112 has an angular measurement of 40 degrees.

However, the sizes of the first and second teeth 116, 122 and/or of the respective rings may vary in other embodiments. For example, a larger size for the first and second teeth 116, 122, and/or a ring with a larger circumference, may be utilized in conjunction with components 102 that are relatively larger in size, as compared to an exemplary embodiment described herein in which the component 102 comprises an air filter for a vehicle. Preferably, the size and design of the teeth 116, 122 are preferably dependent on the components being used, the material the components will be made out of and the process by which the engagement features (teeth) are manufactured.

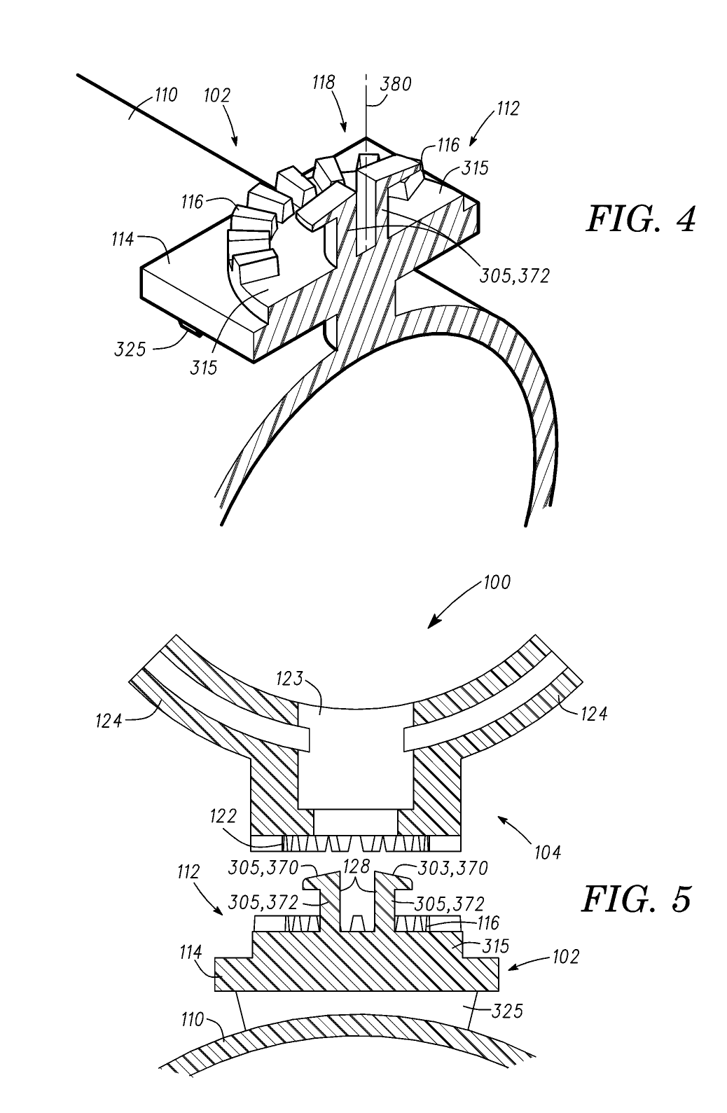

FIGS. 3 and 4 provide close-up views of a portion of the system 100 of FIGS. 1 and 2, in accordance with an exemplary embodiment. Specifically, FIG. 3 is a close-up plan view of a portion of the system 100 of FIGS. 1 and 2, including the engagement device 112 of FIGS. 1 and 2. FIG. 4 is a close-up cross sectional view of a portion of the system 100 of FIGS. 1 and 2, including the engagement device 112 of FIGS. 1 and 2.

As depicted in FIGS. 3 and 4, a support 325 is disposed between, and connects, the above-referenced base 110 and plate 114 of FIGS. 1 and 2. In addition, a ring 315 is disposed between, and connects, the plate 114 and the first teeth 116 of FIGS. 1 and 2. The base 110, the plate 114, the support 325, and the ring 315 are preferably molded together as a single piece, most preferably via a plastic mold, although they may be separately formed and connected, as well.

In addition, in the embodiment of FIGS. 3 and 4, the first teeth 116 comprise two teeth sections 360, 362 on opposing sides of the ring 315. Within each teeth section 360, 362, the first teeth 116 are disposed approximately fifteen degrees apart in the depicted embodiment. In one embodiment, the teeth sections 360, 362 are separated by two gaps 317, 319 on opposing sides of the ring 315. The gaps 317, 319 facilitate the manufacturing the protrusions 305 and 370.

Also as depicted in FIGS. 3 and 4, the integrated fastening device 118 comprises a plurality of protrusions 305. Each protrusion 305 includes a first portion 370 and a second portion 372. The first portions 370 contact and extend generally upward from the ring 315, in a direction that is substantially perpendicular to the ring 315. The second portions 372 diverge away from a central axis 380 that is perpendicular to the 315. The second portions 372 extend from the respective first portions 370, and are substantially perpendicular to the first portions 370 in a plane that is parallel with the ring 315. As depicted in FIGS. 3 and 4, the integrated fastening device 118 includes two protrusions 305, each having its own respective first and second portions 370, 372. However, the number of protrusions 305 and/or respective portions thereof may vary in other embodiments.

In the depicted embodiment of FIGS. 3 and 4, the protrusions 305 are configured to snap against the surface 128 of the inner portion 126 of the base 123 of the attachment device 104 of FIGS. 1 and 2, to thereby further secure the component 102 (and the engagement device 112 thereof) to the attachment device 104 and inhibit (and, preferably, prevent) separation of the component 102 and the attachment device 104. In one embodiment, the protrusions 305 can freely rotate so as to allow the component 102 to be mounted at a variety of angles with respect to the attachment device 104. Once the teeth 116 and 122 have become engaged to each other, the protrusions 305 will have already snapped into their assembled position, and will not be capable of rotating.

In other embodiments, the integrated fastening device 118 may have a different configuration from that depicted in FIGS. 3 and 4 and/or that described above in connection therewith. In one embodiment, the integrated fastening device 118 could be one of an integrated source, or could allow a separate fastener such as a bolt or screw to be used, passing through the engagement device 112 and into the attachment device 104 via an internally threaded boss.

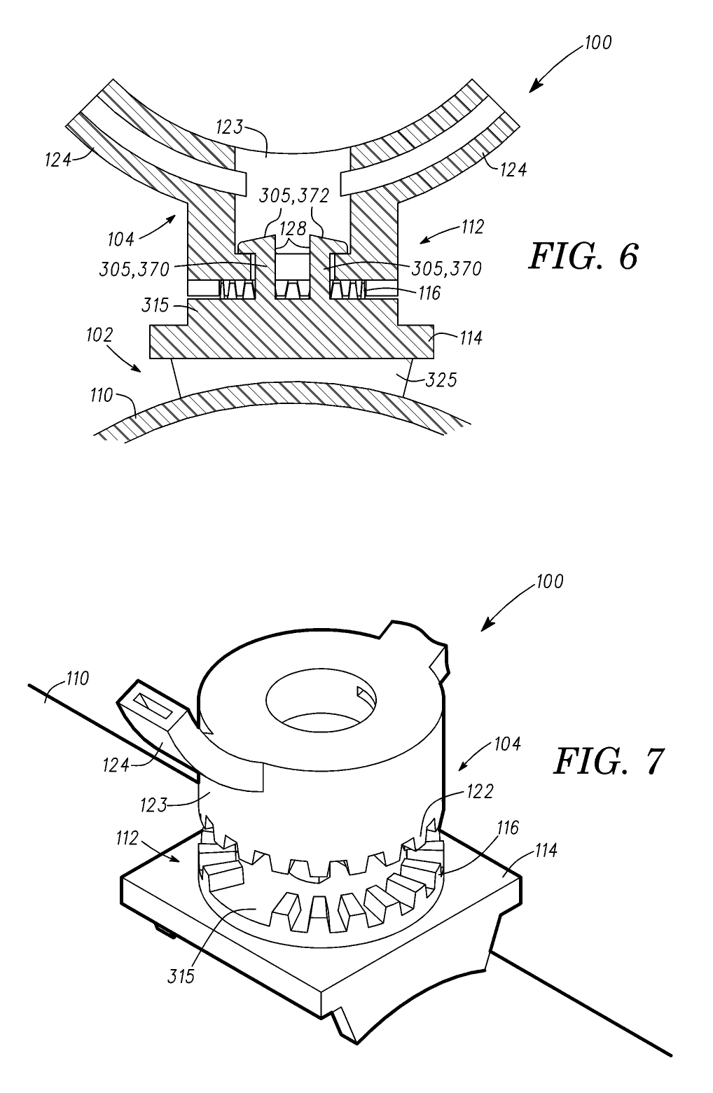

FIGS. 5 and 6 are cross sectional views of a portion of the system 100 of FIGS. 1 and 2, in accordance with an exemplary embodiment. The portion of the system 100 depicted in FIGS. 5 and 6 includes the engagement device 112 of FIGS. 1-4 (and, specifically, having the protrusions 305 of FIGS. 3 and 4), and further includes the attachment device 104 of FIGS. 1 and 2. Specifically, FIG. 5 depicts the portion of the system 100 as the protrusions 305 are beginning to engage the attachment device 104 (preferably, to the inner surface 128 of the base 123 thereof). FIG. 6 depicts the portion of the system 100 as the protrusions 305 are fully engaged to the attachment device 104 (preferably, to the inner surface 128 of the base 123 thereof). As shown in FIGS. 5 and 6, the inner surface 128 preferably includes a shelf 580 against which the second portion 372 (preferably, a bottom segment thereof) rests against when the protrusions 305 snap into place.

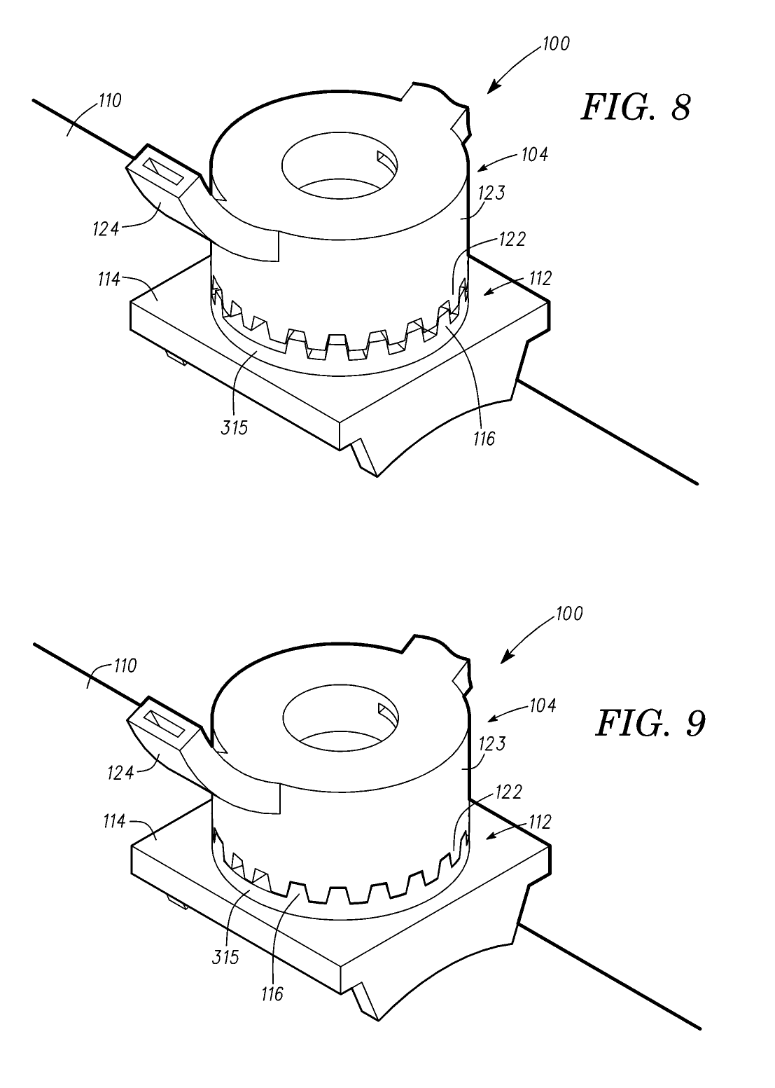

FIGS. 7-9 are close-up perspective views of a portion of the system 100 of FIGS. 1 and 2, in accordance with an exemplary embodiment. The portion of the system 100 depicted in FIGS. 7-9 including the engagement device 112 and the attachment device 104 of FIGS. 1-6. FIGS. 7-9 provide close-up views of the interaction between the first and second teeth 116. Specifically, FIG. 7 depicts the portion of the system 100 at a point in time in which the integrated fastening device 118 of FIGS. 1-6 is secured with the attachment device 104, and in which the first and second teeth 116, 122 are not yet interlocked or engaged. FIG. 8 depicts the portion of the system 100 at a point in time in which the integrated fastening device 118 is secured with the attachment device 104, and in which the first and second teeth 116, 122 are partially interlocked and engaged. FIG. 9 depicts the portion of the system 100 at a point in time in which the integrated fastening device 118 is secured with the attachment device 104, and in which the first and second teeth 116, 122 are fully interlocked and engaged (which is preferably a final, resting position of the system 100), and in which rotation of the component 102 is at least inhibited, and is preferably prevented through the engagement of the first and second teeth 116, 122.

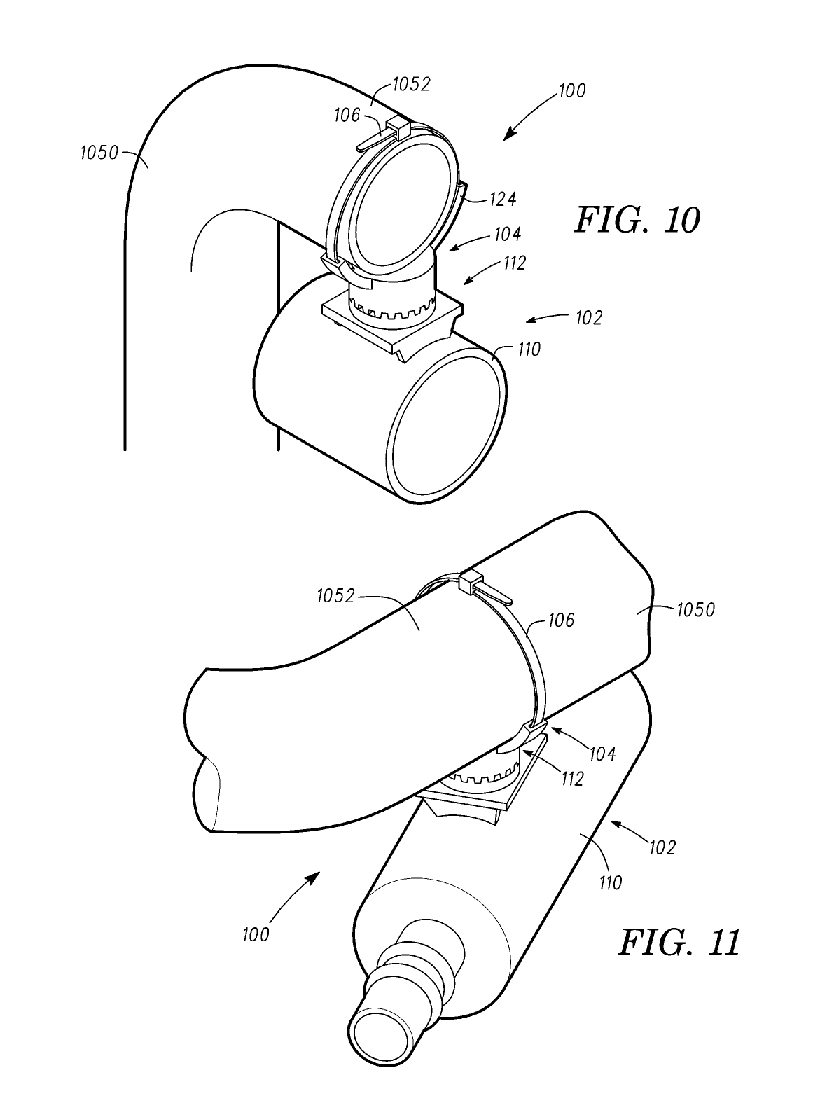

FIGS. 10-13 depict various views of the system 100 as mounted against another component 1050, in accordance with an exemplary embodiment. As depicted in FIGS. 10-13, the component 102 comprises an air filter for a vehicle, and the other component 1050 comprises a fill pipe 1050 for the vehicle. The fill pipe 1050 includes a neck 1052 on which the air filter 102 is mounted.

Specifically, FIG. 10 provides a cross sectional view of the mounting of the system 100 and the other component 1050. As shown in FIG. 10, the tie rod 106 of the system 100 is utilized to tie the component 102 (including the engagement device 112 thereof) along with the attachment device 104 attached thereto to the neck 1052 of the other component 1050. The component 102 (and the housing thereof) is locked into place, and rotation thereof is at least inhibited (and is preferably prevented) by the mating of the attachment device 104 and the engagement device 112. Specifically, the first teeth 116 and the second teeth 122 lock and engage with one another, to inhibit (and preferably prevent) such rotation (as depicted in FIGS. 1-9). Separation of the engagement device Rotation is further inhibited (and preferably prevented) by the engagement of the integrated fastening device 118 with the attachment device 104 (also as depicted in FIGS. 1-9). The integrated fastening device 118 helps to secure to attachment device 104 to the engagement device 112.

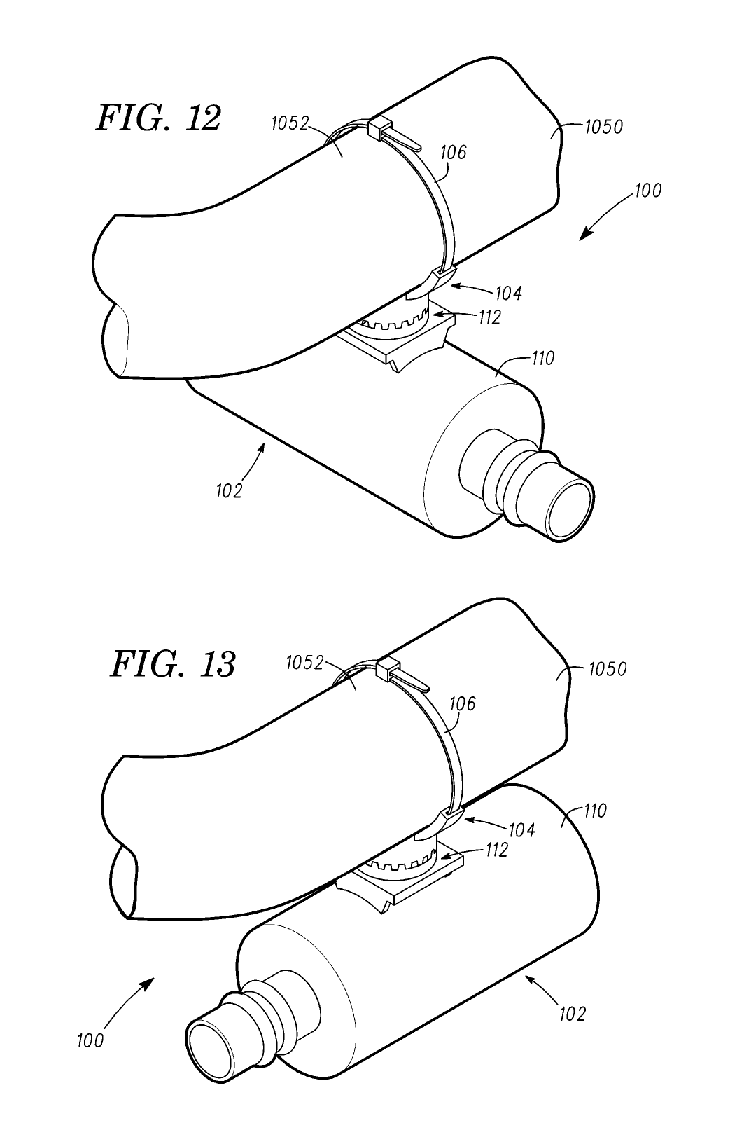

In addition, FIGS. 11-13 provide various plan views of the mounting of the system 100 and the other component 1050, illustrating various possible mounting angles therebetween. Specifically, FIG. 11 depicts an exemplary mounting of the component 102 of the system 100 at an angle of forty five degrees with respect to the neck 1052 of the other component 1050. FIG. 12 depicts an exemplary mounting of the component 102 of the system 100 at an angle of ninety degrees with respect to the neck 1052 of the other component 1050, so that the component 102 and the neck are perpendicular to one another. FIG. 13 depicts an exemplary mounting of the component 102 of the system 100 at an angle of zero degrees with respect to the neck 1052 of the other component 1050, so that the component 102 and the neck are parallel to one another.

As illustrated in FIGS. 11-13, the system 100 allows for variability in the angle at which the component 102 is mounted against the other component 1050. The system 100 may similarly be configured to provide various other mounting angles for the component 102 with respect to the other component 1050. As described above, for a particular component 102, various different mounting angles may be required or desired for different other components 1050. For example, different other components of different types of vehicles may involve different geometries and/or different surrounding apparatus that may make such different mounting angles necessary or desirable.

The system 100 allows for such variability of mounting examples, for example via the positioning and interaction between the first teeth 116 of the engagement device 112 and the second teeth 122 of the attachment device 104, while still maintaining the desired ant-rotation feature. This in turn can provide for improved mounting of the component 102 with different types and/or configurations of other components 1050, for example by changing the angle of engagement of the first and second teeth 116, 122, rather than requiring differently designed mounting and anti-rotation devices. This can therefore result in more streamlined and inexpensive production, manufacturing, and assembly of the components 102, 1050 and the environments in which they are implemented, such as in vehicles.

Accordingly, improved devices and systems are provided for mounting various components with one another, for example in automobiles, other vehicles, and/or other systems and/or devices. The disclosed devices and systems allow for improved mounting of components at one of a number of predetermined angles with respect to other components to which they are mounted, while inhibiting or preventing unwanted rotation of the components. In addition, the disclosed devices and systems provide for more efficient and streamlined manufacturing of the components and the devices in which they are implemented, for example as compared with certain existing techniques in which more expensive metal brackets are utilized. It will be appreciated that the disclosed devices and systems may vary from those depicted in the Figures and described herein.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A system configured to mount a first component to a second component, the system comprising:
an engagement device attached to the first component; and
an attachment device configured to mate with the engagement device to thereby provide mounting of the first component at one of a plurality of angles with respect to the second component while at least inhibiting rotation of the first component with respect to the second component.

2. The system of claim 1, wherein the first component comprises an air filter for a vehicle.

3. The system of claim 1, further comprising:
a tie rod configured to be threaded through the attachment device to facilitate mounting against the second component.

4. The system of claim 1, wherein:
the engagement device includes a first plurality of teeth; and
the attachment device includes a second plurality of teeth that are configured to engage the first plurality of teeth.

5. The system of claim 4, wherein the one of the plurality of angles is attained for the mounting of the first component against the second component by selectively aligning the first plurality of teeth and the second plurality of teeth.

6. The system of claim 4, wherein the engagement device further comprises:
a base; and
a plate connecting the base and the first plurality of teeth, wherein the plate and the first plurality of teeth are molded into the first component as a single piece.

7. The system of claim 4, wherein the engagement device also includes an integrated fastening device for fastening the attachment device to the engagement component.

8. The system of claim 7, wherein the integrated fastening device comprises a plurality of protrusions configured to snap fit with the attachment device.

9. A system for mounting a device against a component, the device having a housing, and the system comprising:
a first plurality of teeth integrally formed with the housing; and
a second plurality of teeth formed separately from the housing and configured to engage the first plurality of teeth, to thereby provide mounting of the housing at one of a plurality of angles with respect to the component while at least inhibiting rotation of the housing with respect to the component.

10. The system of claim 9, wherein the device comprises an air filter for a vehicle.

11. The system of claim 9, wherein the one of the plurality of angles is attained for the mounting of the housing against the component by selectively aligning the first plurality of teeth and the second plurality of teeth.

12. The system of claim 9, wherein the second plurality of teeth are formed as part of an attachment device, and the system further comprises:
an integrated fastening device integrally formed with the housing for fastening to the attachment device.

13. The system of claim 12, wherein the first plurality of teeth and the integrated fastening device are molded together with the housing as a single piece.

14. The system of claim 12, wherein the integrated fastening device comprises a plurality of protrusions configured to snap fit with the attachment device.

15. A device configured to be mounted against a component, the device comprising:
a housing; and
a first plurality of teeth integrally formed with the housing, the first plurality of teeth configured to mate with a second plurality of teeth, to thereby provide mounting of the housing at one of a plurality of angles with respect to the component while at least inhibiting rotation of the housing with respect to the component.

16. The device of claim 15, wherein the device comprises an air filter for a vehicle.

17. The device of claim 15, wherein the one of the plurality of angles is attained for the mounting of the housing against the component by selectively aligning the first plurality of teeth and the second plurality of teeth.

18. The device of claim 15, wherein the second plurality of teeth are formed as part of an attachment device, and the device further comprises:
an integrated fastening device integrally formed with the housing for fastening to the attachment device.

19. The device of claim 18, wherein the first plurality of teeth and the integrated fastening device are molded together with the housing as a single piece.

20. The device of claim 18, wherein the integrated fastening device comprises a plurality of protrusions configured to snap fit with the attachment device.
